(19) United States
(12) Patent Application Publication
(10) Pub. No.: US 2010/0123432 A1
(43) Pub. Date: May 20, 2010

(54) Battery charger

(75) Inventor: Ulrich Schiestl, Feldkirch (AT)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/590,744

(22) Filed: Nov. 12, 2009

(30) Foreign Application Priority Data
Nov. 19, 2008 (DE) DE 102008043852.9

(51) Int. Cl. H02J 7/00

(52) U.S. Cl. 320/115; 320/111

(57) ABSTRACT

The present invention relates to a battery charger (30) including a housing (40), having an electronic charging unit (33) and a cradle (31) for a battery pack (10) that has electric counter-contact elements (38) for contact elements (18) of the battery pack (10). The battery charger (30) also has a filling device to fill gas reservoirs such as, for instance, pressure vessels, with gaseous media, said filling device being configured as a compressor to generate compressed air.

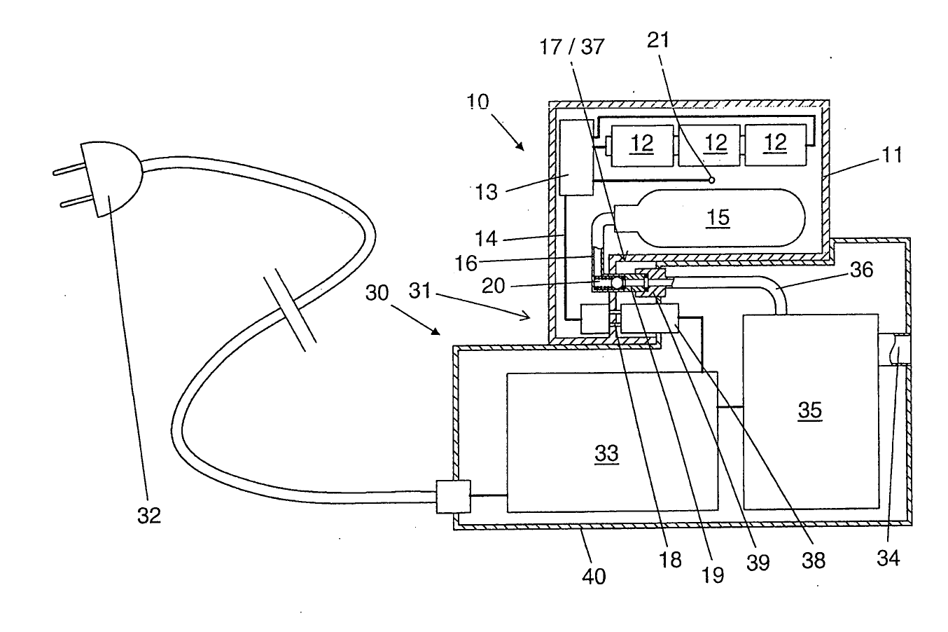

This claims the benefits of German Patent Application No. 10 2008 043 852.9, filed Nov. 19, 2009 and hereby incorporated by reference herein.

The present invention relates to a battery charger. Such battery chargers usually have a mains connection to supply power and at least one cradle for a battery or battery pack.

### BACKGROUND

U.S. patent publication US2007/0236177A discloses a generic battery charger including a housing, an electronic charging unit arranged in the housing, a cradle to hold a battery that is to be charged and counter-contact elements arranged in the area of the cradle for the contact elements of the battery.

### SUMMARY OF THE INVENTION

A battery can be electrically recharged by means of this battery charger. In a parallel patent application of the applicant, a battery pack is claimed that not only entails the possibility to store electric current but that also has a gas reservoir to store a gaseous medium that is under pressure such as, for example, compressed air. With a conventional battery charger, only the battery cells of this battery pack can be charged, while the gas reservoir has to be charged using a separate charger.

It is an object of the present invention to develop a battery charger of the above-mentioned type that allows the battery cells to be charged with electric energy and, in parallel, the gas reservoir to be charged with a gaseous medium.

The present invention provides a battery charger having a housing, an electronic charging unit and a cradle for a battery pack that has electric counter-contact elements for contact elements of the battery pack. The battery charger has a filling device to fill gas reservoirs such as, for instance, pressure vessels, with gaseous media. As a result, a battery pack that is attached to the battery charger can be charged with electric energy while simultaneously, its gas reservoir can be filled with a gaseous medium or compressed air.

Advantageously, the filling device includes a compressor that generates compressed air and that is pneumatically connected to at least one connection means for an output port of a gas reservoir. In a simple manner, the (electrically operated) compressor can generate compressed air, with which a gas reservoir configured as a pressure vessel can be refilled in the battery pack. Moreover, the compressor could also provide compressed air for other applications via the battery charger. For this purpose, the charger could be operated via a selector switch in various modes, at least one of which allows it to be operated exclusively as a compressor.

It is likewise advantageous for the counter-contact elements and the at least one connection means to be arranged on a shared counter-connection port so that, when the battery pack is coupled to the battery charger, the contact elements and the output port of the battery pack are simultaneously connected to the counter-contacts and to the connection means located on the charger.

It is likewise practical for the filling device to be controlled via the electronic charging unit. In this context, the electronic charging unit can recognize, preferably automatically, whether a (or the correct) battery pack is attached to the charger and can then automatically switch on the filling device. Moreover, the electronic charging unit can communicate with the electronic unit of the battery and, in this manner, can monitor the charging procedure of the gas reservoir by means of appropriate sensors (e.g. pressure sensor, temperature sensor) located on the gas reservoir. In this context, it is advantageous for the compressor of the filling device to be electrically connected to the electronic charging unit, so that the compressor can be controlled by the electronic charging unit as a function of the sensor data.

### BRIEF DESCRIPTION OF THE DRAWING

The drawing is a view of one embodiment of the battery charger of the present invention.

### DETAILED DESCRIPTION

The invention is presented in the drawing with reference to an embodiment, whereby the drawing shows a battery charger 30 with a battery pack 10 attached to it.

The battery pack 10 has a housing 11 and a plurality of battery cells 12 that are electrically connected to each other and arranged in the housing 11. In this context, the battery pack can be configured, for instance, as a lithium-titanate, NiCd, NiMH, Li-ion, Li-polymer or Li—Fe battery.

The battery pack 10 also has an electronic unit 13 configured as an electronic control unit that is electrically connected to the battery cells 12 and monitors them, said electric unit being connected via an electric line 14 to electric contact elements 18 that are arranged on the housing 11. The contact elements 18 are arranged at a connection port 17 that can be connected to a counter-connection port 37 of a battery charger 30, to a hand-held power tool or the like. The electronic unit 13 is also connected to a temperature sensor 21 such as, for instance, an NTC (negative temperature coefficient thermistor), as a result of which the temperature of the battery cells 12 can be monitored.

The housing 11 of the battery pack 10 also contains a gas reservoir 15 configured as a pressure vessel for a gaseous medium that is under pressure such as, for example, compressed air. Here, the gas reservoir 15 is connected via a pressure line 16 to an output port 19 that is arranged adjacent to the contact elements 18 at the connection port 17 on the outside of the housing 11. Moreover, a valve 20 that, without being activated, prevents gas or gaseous medium from flowing out of the gas reservoir 15 is arranged in the line 16 near the output port 19.

The battery charger 30 has a housing 40, an electronic charging unit 33 arranged in this housing 40 as well as a mains connection 32 to supply electric power. Moreover, the battery charger 30 also has a filling device to fill gas reservoirs 15 with gaseous media. The filling device has a compressor 35 to generate compressed air (as the gaseous medium) that is connected via a line 36 to a connection means 39 and that can draw in air, preferably filtered, via an air intake 34. The connection means 39 is arranged together with electric counter-contact elements 38 at a counter-connection port 37 for the connection port 17 of the battery pack 10 in the area of a cradle 31 of the battery charger 30 for the battery pack 10. When the battery pack 10 is placed into the cradle 31 of the battery charger 30, the connection port 17 is coupled to the counter-connection port 37 and, at the same time, an electric connection is established between the contact elements 18 and the counter-contact elements 38, and a pneumatic connection is established between the output port 19 and the connection means 39. The electronic charging unit 33, which is, on the one hand, electrically connected to the counter-contact elements 38 and, on the other hand, electrically connected to compressor 35, charges the battery cells 12 with electricity and, in parallel to that, once again fills the gas reservoir 15 of the battery pack 10, with gaseous medium in the form of compressed air. The filling procedure of the gas reservoir 15 can be completed considerably faster than the charging procedure of the battery cells 12 of the battery pack 10.

During the operation of the compressor 35, the valve 20 at the output port 19 of the battery pack 10 is automatically opened by the excess pressure generated by the compressor in order to allow the gas reservoir to be filled with compressed air. In this process, the valve 20 remains open until the pressure in the gas reservoir 15 has reached a certain value that corresponds to the excess pressure generated by the compressor.

What is claimed is:

1. A battery charger comprising:
a housing;
an electronic charging unit;
a cradle for a battery pack, the cradle having electric counter-contact elements for contact elements of the battery pack; and
a filling device to fill at least one gas reservoir with gaseous media.

2. The battery charger according to claim 1 wherein the filling device includes a compressor generating compressed air, the compressor pneumatically connected to at least one connector for an output port of the at least one gas reservoir.

3. The battery charger according to claim 1 wherein the counter-contact elements and the at least one connector are arranged on a shared counter-connection port.

4. The battery charger according to claim 1 wherein the filling device can be controlled via the electronic charging unit.

5. The battery charger according to claim 1 wherein the compressor is electrically connected to the electronic charging unit.
